(19) United States
(12) Patent Application Publication
(10) Pub. No.: US 2004/0157968 A1
(43) Pub. Date: Aug. 12, 2004

(54) Polymeric composition

(76) Inventors: John Nicholas Marston, Redcar (GB); Mark Davies, Redcar (GB); John Robert Oliver, Redcar (GB)

Correspondence Address: VENABLE, BAETJER, HOWARD AND CIVILETTI, LLP, P.O. BOX 34385, WASHINGTON, DC, 20043-9998, US

(21) Appl. No.: 10/474,735

(22) PCT Filed: Apr. 11, 2002
(86) PCT No.: PCT/GB02/01628

(30) Foreign Application Priority Data
Apr. 11, 2001 (GB) 0109080.2
Oct. 23, 2001 (GB) 0125347.5

(51) Int. Cl. C08L 77/00; C08L 23/00

(52) U.S. Cl. 524/178; 525/179; 525/227

(57) ABSTRACT

A composition comprising a polymer selected from a polyolefin, a polyamide or mixture thereof, in admixture with an acrylic polymer additive, wherein: the shear viscosity of the composition is less than the shear viscosity of the same composition not containing the acrylic polymer; or, the extensional viscosity of the composition is less than the extensional viscosity of the same composition not containing the acrylic polymer additive; or, both of the shear viscosity and extensional viscosity of the composition is less than the shear viscosity and extensional viscosity of the same composition not containing the acrylic polymer addictive,when measured at an identical applied specific shear rate in the range of 5000 s⁻¹ to 500 s⁻¹ under substantially the same conditions.

The present invention relates to a polymeric composition, a process for producing a polymeric composition, and an article formed from the polymeric composition. In particular, although not exclusively, the invention relates to a polyolefin and/or a polyamide having a modified melt-rheology and the use of such modified polymers for forming an article, particularly a fibre, by a high speed spinning process.

Various methods for spinning polymer mixtures are known. Typically, these methods focus on increasing the productivity and profitability of the spinning process by striking a balance between increasing the speed of taking up the spun yarn and the extent of the residual elongation of the resultant yarn. If the speed of taking up the spun yarn is increased then the amount of melt extruded from a spinneret is also increased. However, increasing the take up speed typically enhances the molecular orientation of the spun yarn which results in a reduction of the residual elongation of the resultant undrawn yarn. Consequently, the efficiency of a subsequent drawing or draw texturising step is reduced as the spun yarn possesses a lower elongation at break compared to a yarn which is spun at a lower speed.

Attention has therefore been focussed on spinning polymeric mixtures (i.e. a polymer and additive polymer) to form synthetic fibres that possess a higher elongation at break in the strand at a particular spinning speed compared to the polymer itself which has not been modified by the inclusion of an additive polymer. Consequently, a higher stretching ratio for production of the final yarn is said to be possible thereby resulting in a higher productivity of the spinning unit.

It is also recognised that the productivity of the spinning process depends on other factors such as: the thermal stability of the polymeric mixture and the resulting yarn; the availability and cost of the additives; the requirement for complex and expensive high speed production facilities; and the ease by which the spun yarn may be subjected to secondary processes, such as drawing and draw texturising.

A particular technical problem associated with processing polymeric mixtures comprising a polymer matrix and a polymer additive, is the influence of the additive upon the thermal stability of the polymeric mixture during processing and the resultant product such as a fibre product, film or polymeric shaped article. Suitably, the temperature required to melt process the polymer matrix itself, such that the polymeric mixture has a melt viscosity which is sufficiently low to permit the mixture to be processed (e.g. taken up as a fibre or filling a mould), may be considerably higher than that required to process the additive polymer. Consequently, the additive polymer may degrade during processing, for example resulting in the production of volatile species, thereby lowering the overall efficiency of the process and having a detrimental effect upon the ultimate end product e.g. yarn, film or shaped article. Degradation of the additive polymer may adversely affect the thermal stability (i.e. lower the thermal stability), the mechanical properties and appearance of the polymer mixture and ultimate end product.

For example, where the polymeric mixture is employed in a spinning process, degradation of the additive material may produce a discoloured product yarn which may render the yarns sub-standard and/or may necessitate correction before dyeing. Moreover, degradation of the additive polymer may prevent the polymeric mixture from being spun at enhanced take-up speeds and a fibre produced therefrom may not possess the desired elongation at break. When the polymeric mixture is employed in a film forming or moulding process, degradation of the additive material may produce a polymeric mixture which does not have the is desired mechanical and heat resistance properties such that it may be formed into a film or a shaped article. Suitably, the overall effect resulting from the thermal instability of the additive polymer and/or the polymeric mixture may be a decrease in the overall efficiency of the product (i.e. yarn, film or shaped article) producing process.

The present invention therefore seeks to solve the aforementioned problems associated with a polymeric mixture comprising a polymer matrix including an additive polymer.

According to a first aspect, the present invention provides a composition comprising a polymer selected from a polyolefin, a polyamide or mixtures thereof, in admixture with an acrylic polymer additive, wherein:

the shear viscosity of the composition is less than the shear viscosity of the same composition not containing the acrylic polymer; or,

the extensional viscosity of the composition its less than the extensional viscosity of the same composition not containing the acrylic polymer additive; or,

both the shear viscosity and extensional viscosity of the composition is less than the shear viscosity and extensional viscosity, respectively, of the same composition not containing the acrylic polymer additive, when measured at an identical applied specific shear rate. in the range of 5000 s⁻¹ to 500 s⁻¹ under substantially the same conditions. Such a composition is referred to hereinafter as the composition of the present invention.

By the term “same composition not containing the acrylic polymer additive” we mean a substantially identical composition of the present invention not containing the acrylic polymer additive.

According to a preferred embodiment of the present invention there is provided a composition comprising a polymer selected from a polyolefin, a polyamide or mixtures thereof, in admixture with an acrylic polymer additive, wherein the shear viscosity of the composition is lower than the shear viscosity of the same composition in the absence of the acrylic polymer additive when measured at an applied specific shear rate in the range of 5000 s⁻¹ to 500 s⁻¹ under substantially the same conditions.

Preferably, the shear viscosity of the composition of the present invention is lower than the shear viscosity of the polymer alone (i.e. polyamide or polyolefin in or mixtures thereof) in the absence of the acrylic polymer additive when measured at an applied specific shear rate in the range of 5000 s⁻¹ to 500 s⁻¹ under substantially the same conditions.

According an alternative preferred embodiment of the present invention there is provided a composition comprising a polymer selected from a polyolefin, a polyamide or mixtures thereof, in admixture with an acrylic polymer additive, wherein the extensional viscosity of the composition is lower than the extensional viscosity of the same composition in the absence of the acrylic polymer additive when measured at an applied specific shear rate in the range of 5000 s⁻¹ to 500 s⁻¹ under substantially the same conditions.

Preferably, the extensional viscosity of the composition of the present invention is lower than the extensional viscosity of the polymer alone (i.e. polyamide or polyolefin or mixtures thereof) in the absence of the acrylic polymer additive when measured at an applied specific shear rate in the range of 5000 s⁻¹ to 500 s⁻¹ under substantially the same conditions.

The composition according to the present invention seeks to solve the aforementioned technical problems associated with polymer mixtures comprising a polymer matrix and a polymer additive. In particular, the composition of the present invention during processing may exhibit a reduced extensional viscosity, and/or shear viscosity, in comparison with the same composition not containing the acrylic polymer additive. This in turn may permit greater freedom in processing conditions. Suitably, the processing temperature of the composition of the present invention may be reduced compared to the same composition not containing the acrylic polymer additive, such that the composition of the present invention has a sufficiently low melt viscosity to permit it to be processed into the ultimate end product. Conveniently, the acrylic polymer additive may be inexpensive to produce. Conveniently, the composition of the present invention may be formed into films or moulded into shaped articles more efficiently. For example, larger mouldings may be filled, mouldings having an intricate shape may be moulded with greater precision and fillers may be included at higher concentrations for a given melt viscosity compared with the same composition not containing the acrylic polymer additive. Conveniently, the composition of the present invention may be spun at increased take-up speeds to produce a fibre, which typically may have a high elongation at break, compared to the same composition not including the acrylic polymer additive. Suitably, fibres produced from the composition of the present invention may be suitable for stretch texturising.

Consequently, an overall increase in efficiency and productivity of a fibre forming, film forming or moulding process may be attained employing the composition of the present invention in comparison to the same composition not containing the acrylic polymer additive.

Moreover, the composition of the present invention and/or the resultant end product (i.e. fibre, film, shaped article) formed therefrom may have a thermal stability that is similar to that of the same composition not containing the acrylic polymer additive. Thus thermal degradation of the composition of the present invention may be avoided during processing, particularly as lower processing temperatures may be employed. Furthermore, the composition of the present invention may be thermoplastically processed under conditions similar to those used for the same composition not containing the acrylic polymer additive, thereby negating the need to modify equipment for processing the composition of the present invention.

By the term “shear viscosity” we include the internal resistance to flow, such as the ratio of shearing stress to the rate of shear, exhibited by a molten polymer per se or molten polymeric mixture (i.e. the molten composition of the present invention). In other words, a molten polymer or molten polymeric composition having a lower shear viscosity requires less force per unit area to cause two parallel polymer surfaces of unit area and unit distance apart to move past each other at unit velocity compared to a molten polymer and molten polymeric composition, respectively, having a higher shear viscosity i.e. shear viscosity relates to rotational flow.

By the term “extensional viscosity” we include the ability of a molten polymer per se or molten polymeric mixture (i.e. the molten composition of the present invention) to be drawn or pulled apart i.e. a non-rotational flow. In other words, a molten polymer or molten polymeric composition having a lower extensional viscosity requires less force to extend the polymer or polymeric composition, respectively, over a unit length than a molten polymer or molten polymeric composition having a higher extensional viscosity.

Conveniently, the efficiency of a process which is dependent, at least in part, on the extensional viscosity and/or shear viscosity of a polymer or polymeric composition, such as high speed fibre spinning, film forming and blow moulding, may be increased by decreasing the extensional viscosity, and/or decreasing the shear viscosity, of the polymer or polymeric composition, provided that other factors, such as the thermal stability of the polymer or polymeric composition, are not significantly effected, as is typically the case with the composition of the present invention.

It will be appreciated by those skilled in the art that the extensional viscosity and shear viscosity of a molten polymer per se or molten polymeric mixture may depend on various factors, such as the temperature of the molten polymer or molten polymeric mixture, respectively, and the shear rate applied to the molten polymer or molten polymeric mixture. Consequently, in order to make comparisons between extensional viscosities and shear viscosities of molten polymers and/or molten polymeric mixtures it is typically necessary to apply a substantially identical specific shear rate to each of the molten polymers and/or molten polymeric compositions, wherein the molten polymers and/or molten polymeric compositions are at substantially identical temperatures. This is what we mean by “substantially the same conditions”.

Moreover, the extensional viscosity and shear viscosity of a molten polymer or molten polymeric mixture at a specific applied shear rate may depend on whether the specific applied shear rate is attained by increasing or decreasing the shear rate applied to the polymer or polymeric mixture.

Preferably, the specific identical shear rate applied to the molten polymer and/or molten polymeric compositions is attained in the same manner (i.e. by decreasing or increasing the applied shear rate).

Accordingly, by the term “when measured at an applied identical shear rate in the range of 5000 s⁻¹ to 500 s⁻¹ under substantially the same conditions” in relation to extensional viscosity and shear viscosity, respectively, we mean the extensional viscosity or shear viscosity of the molten composition of the present invention, of the same molten composition of the present invention not containing the acrylic polymer additive and of the molten polymer alone in the absence of the acrylic polymer additive, respectively, when an identical specific shear rate of less than or equal to 5000 s⁻¹ and greater than or equal to 500 s⁻¹ is applied to each of the compositions and polymer alone, respectively, and the temperature of each of the molten compositions and molten polymer alone is substantially identical. Preferably, the identical specific shear rate applied to each of the molten compositions or molten polymer alone, respectively, is attained in the same manner.

Suitably, when performing comparative measurements of extensional viscosity or shear viscosity, respectively, of the composition of the present invention, the polymer alone in the absence of the acrylic polymer additive, and the same composition of the present invention not containing the acrylic polymer additive, respectively, then these may be measured at substantially identical melt temperatures in the processing range of the polymer itself. The processing range of a given polymer may be regarded as the range between the minimum temperature at which individual particles of the polymer are fused together when subjected to heat or to a combination of heat and work on the polymer matrix, such that the polymer may be processed i.e. the polymer is molten, before degradation of the polymer has an unacceptable effect on the properties of the polymer. Typically, the inclusion of the acrylic polymer additive in the composition of the present invention may reduce the minimum processing temperature of the polymer.

Preferably, when performing comparative measurements of extensional viscosity or shear viscosity, respectively, the melt temperature of the polymer alone in the absence of acrylic polymer additive, the composition of the present invention and the same composition of the present invention not containing the acrylic polymer additive, is less than or equal to 330° C., more preferably less than or equal to 320° C., even more preferably less than or equal to 310° C. Preferably, when performing comparative measurements of extensional viscosity or shear viscosity, respectively, the melt temperature of the polymer alone, the composition of the present invention and the same composition of the present invention not containing the acrylic polymer additive, is greater than or equal to 170° C., more preferably greater than or equal to 190° C., even more preferably greater than or equal to 200° C., even more preferably greater than or equal to 220° C., even more preferably greater than or equal to 240° C., even more greater than or equal to 260° C., more preferably greater than or equal to 270° C. i.e. at or above the operating temperature of the process at which the polymeric composition of the present invention and polymer alone is molten. It will however be appreciated that the extensional viscosity or shear viscosity, respectively, may be measured at lower temperatures, such as 190° C. to 210° C., provided that the material in question, such as the polymer alone and the composition of the present invention, is molten at such a temperature.

More preferably, the extensional viscosity or shear viscosity, respectively, of the polymer alone in the absence of the acrylic polymer additive, the composition of the present invention, and the same composition of the present invention not containing the acrylic polymer additive is measured at a substantially identical temperature in the range of 270° C. to 320° C., most preferably greater than or equal to 290° C., especially at 290° C., when the polymer includes a polyamide as defined herein.

More preferably, the extensional viscosity or shear viscosity, respectively, of the polymer alone, the composition of the present invention, and the same composition of the present invention not containing the acrylic polymer additive is measured at substantially the same temperature in the range of 170° C. to 230° C., when the polymer includes a polyolefin as defined herein, most preferably greater than or equal to 190° C., especially 190° C., when the polyolefin comprises polyethylene and at greater than or equal to 230° C., especially 230° C., when the polyolefin comprises polypropylene.

Preferably, the identical specific shear rate applied to the composition of the present invention, to the polymer alone in the absence of the acrylic polymer additive, and the same composition of the present invention not containing the acrylic polymer additive, respectively, may be obtained by reducing the shear rate applied to each molten composition and molten polymer alone, respectively, from a higher value to a lower value. In other words, when measuring the extensional viscosity or shear viscosity of the composition of the present invention and the polymer alone in the absence of the acrylic polymer, at an applied specific shear rate of, for example, 3000 s⁻¹ then this may be obtained by initially applying a higher shear rate to both the composition of the present invention and polymer alone, for example 5000 s⁻¹, and then reducing the shear rate to the desired applied specific shear rate i.e. from 5000 s⁻¹ to 3000 s⁻¹.

Typically, when performing comparative measurements of the shear viscosity and extensional viscosity of the composition of the present invention, the polymer alone in the absence of the acrylic polymer additive and the same composition of the present invention not containing the acrylic polymer additive, then these are performed by applying a higher initial shear rate of 10,000 s⁻¹ to each of the molten compositions and the molten polymer alone, respectively, and then reducing the higher initial shear rate in stepwise fashion to 5000 s⁻¹, then to 3000 s⁻¹, then to 1500 s⁻¹, then to 1000 s⁻¹ and then to 500 s⁻¹, until the desired applied specific shear rate is attained.

Suitably, the shear viscosity of a molten polymer or polymeric composition of the present invention is measured at a shear rate of greater than or equal to 50 s⁻¹, preferably greater than or equal to 100 s⁻¹, most preferably greater than or equal to 150 to 500 s⁻¹.

Suitably, the shear viscosity of the molten polymer or molten polymeric composition of the present invention is measured at a shear rate of less than or equal to 10,000 s⁻¹, preferably less than or equal to 5000 to 3000 s⁻¹ Preferably, when performing comparable measurements of extensional viscosity and shear viscosity, respectively, then an identical specific shear rate of 5000 s⁻¹, 3000 s⁻¹ or 1500 s⁻¹ is applied to the composition of the present invention, the same composition of the present invention not containing the acrylic polymer additive and the polymer alone, respectively. More preferably an identical specific shear rate of 5000 s⁻¹ or 3000 s⁻¹ is applied to each of said compositions and the polymer alone respectively. Most preferably an identical specific shear rate of 3000 s⁻¹ is applied to each of said compositions and the polymer alone, respectively.

Suitably, the composition of the present invention may have a shear viscosity of less than or equal to 99%, preferably less than or equal to 98%, more preferably less than or equal to 97%, more preferably less than or equal to 96%, even more preferably less than or equal to 95%, even more preferably less than or equal to 90%, even more preferably less than or equal to 88%, most preferably less than or equal to 85% of the shear viscosity of the same composition not containing the acrylic polymer additive, particularly the polymer alone in the absence of the acrylic polymer additive.

Suitably, the composition of the present invention has a shear viscosity of greater than or equal to 60%, preferably greater than or equal to 65%, more preferably greater than or equal to 68%, even more preferably greater than or equal to 70%, most preferably greater than or equal to 73% of the shear viscosity of the same composition not containing the acrylic polymer additive, particularly the polymer alone in the absence of the acrylic polymer additive.

Suitably, the composition of the present invention has an extensional viscosity of less than or equal to 98%, preferably less than or equal to 97%, more preferably less than or equal to 95%, more preferably less than or equal to 93%, even more preferably less than or equal to 90%, even more preferably less than or equal to 85%, even more preferably less than or equal to 80%, most preferably less than or equal to 75% of the extensional viscosity of the same composition not containing the acrylic polymer additive, particularly the polymer alone in the absence of the acrylic polymer additive.

Suitably, the composition of the present invention has an extensional viscosity of greater than or equal to 40%, preferably greater than or equal to 45%, more preferably greater than or equal to 50%, even more preferably greater than or equal to 55%, even more preferably greater than or equal to 60%, even more preferably greater than or equal to 65%, even more preferably greater than or equal to 70% of the extensional viscosity of the same composition not containing the acrylic polymer additive, particularly the polymer alone in the absence of the acrylic polymer additive.

Preferably, when the composition of the present invention comprises a polyamide as defined herein, the composition of the present invention has an extensional viscosity of less than or equal to 97%, more preferably less than or equal to 95%, even more preferably less than or equal to 90%, even more preferably less than or equal to 85%, even more preferably less than or equal to 80%, even more preferably less than or equal to 75% of the extensional viscosity of the same composition of the present invention not containing the acrylic polymer additive, particularly the polyamide polymer alone, when measured at an applied specific shear rate of 3000 s⁻¹ at the melt-processing temperature of the polyamide polymer, particularly 290° C.

Preferably, when the composition of the present invention comprises a polyamide as defined herein, the composition of the present invention has an extensional viscosity of greater than or equal to 40%, more preferably greater than or equal to 45%, even more preferably greater than or equal to 50%, even more preferably greater than or equal to 60% of the extensional viscosity of the same composition of the present invention not containing the acrylic polymer additive, particularly the polyamide polymer alone, when measured at an applied specific shear rate of 3000 s⁻¹ at the melt-processing temperature of the polyamide polymer, particularly 290° C.

Preferably, when the composition of the present invention comprises a polyolefin in as defined herein, the composition of the present invention has an extensional viscosity of less than or equal to 98%, more preferably less than or equal to 97%, most preferably less than or equal to 95%, even more preferably less than or equal to 93% of the extensional viscosity of the same composition of the present invention not containing the acrylic polymer additive, particularly the polyolefin polymer alone, when measured at an applied specific shear rate of 3000 s⁻¹ at the melt-processing temperature of the polyolefin polymer, particularly 190° C. to 230° C.

Preferably, when the composition of the present invention comprises a polyolefin as defined herein, the composition of the present invention has an extensional viscosity of greater than or equal to 40%, more preferably greater than or equal to 45%, even more preferably greater than or equal to 50%, even more preferably greater than or equal to 60%, even more preferably greater than or equal to 70%, most preferably greater than or equal to 75% of the extensional viscosity of the same composition of the present invention not containing the acrylic polymer additive, particularly the polyolefin polymer alone, when measured at an applied specific shear rate of 3000 s⁻¹ at the melt-processing temperature of the polyolefin polymer, particularly 190° C. to 230° C.

Preferably, when the composition of the present invention comprises a polyamide as defined herein, the composition of the present invention has a shear viscosity of less than or equal to 97%, more preferably less than or equal to 96%, even more preferably less than or equal to 94%, even more preferably less than or equal to 90%, most preferably less than or equal to 88% of the shear viscosity of the same composition of the present invention not containing the acrylic polymer additive, particularly the polyamide polymer alone, when measured at an applied specific shear rate of 3000 s⁻¹ at the melt-processing temperature of the polyamide polymer, particularly 290° C.

Preferably, when the composition of the present invention comprises a polyamide as defined herein, the composition of the present invention has a shear viscosity of greater than or equal to 60%, more preferably greater than or equal to 65%, even more preferably greater than or equal to 70%, most preferably greater than or equal to 75% of the shear viscosity of the same composition of the present invention not containing the acrylic polymer additive, particularly the polyamide polymer alone, when measured at an applied specific shear rate of 3000 s⁻¹ at the melt-processing temperature of the polyamide polymer, particularly 290° C.

Preferably, when the composition of the present invention comprises a polyolefin as defined herein, the composition of the present invention has a shear viscosity of less than or equal to 99%, more preferably less than or equal to 98%, even more preferably less than or equal to 97% of the shear viscosity of the same composition of the present invention not containing the acrylic polymer additive, particularly the polyolefin polymer alone, when measured at an applied specific shear rate of 3000 s⁻¹ at the melt-processing temperature of the polyolefin polymer, particularly 190° C. to 230° C.

Preferably, when the composition of the present invention comprises a polyolefin as defined herein, the composition of the present invention has a shear viscosity of greater than or equal to 80%, more preferably greater than or equal to 85% of the shear viscosity of the same composition of the present invention not containing the acrylic polymer additive, particularly the polyolefin polymer alone, when measured at an applied specific shear rate of 3000 s⁻¹ at the melt-processing temperature of the polyolefin polymer, particularly 190° C. to 230° C.

Preferably, when performing comparative measurements of the extensional viscosity or shear viscosity, respectively, of the composition of the present invention, the polymer alone in the absence of the acrylic polymer additive and the same composition of the present invention not containing the acrylic polymer additive, sufficient time is allowed to elapse after reducing the shear rate to the desired applied specific shear rate, so that each of the compositions and polymer alone, respectively, have equilibrated at the desired identical applied specific shear rate.

Suitably, each of the compositions and polymer alone, respectively, may be allowed to equilibrate for less than or equal to 400 s, preferably less than or equal to 200 s, preferably less than or equal to 150 s, preferably less than or equal to 100 s, more preferably less than or equal to 75 s after reducing the shear rate from a higher value to the desired identical applied specific shear rate.

Suitably, each of the compositions and the polymer alone, respectively, may be allowed to equilibrate for greater than or equal to 5 s, preferably greater than or equal to 10 s, preferably greater than or equal to 20 s, preferably greater than or equal to 30 s, more preferably greater than or equal to 50 s after reducing the shear rate from a higher value to the desired identical applied specific shear rate.

Preferably, when performing comparative measurements of the extensional viscosity then these may be performed at an extensional stress of greater than or equal to 50 KPa, more preferably greater than or equal to 100 KPa, even more preferably greater than or equal to 120 KPa, even more preferably greater than or equal to 150 KPa, even more preferably greater than or equal to 160 KPa, even more preferably greater than or equal to 180 KPa.

Preferably, when performing comparative measurements of extensional viscosity then these may be performed at an extensional stress of less than or equal to 1200 KPa, preferably less than or equal to 1000 KPa, even more preferably less than or equal to 950 KPa.

Suitably, comparative measurements of the extensional viscosity of the composition of the present invention, the polymer alone, or the same composition of the present invention not containing the acrylic polymer additive may be measured at approximately the same extensional stress as defined above i.e. the extensional stress of the composition of the present invention may be within ±25%, preferably ±20% of the extensional stress of the polymer alone.

Preferably, the physical form of the composition of the present invention, or the same composition of the present invention not containing the acrylic polymer additive, and polymer alone in the absence of the acrylic polymer additive should be substantially identical to each other.

Preferably, the composition of the present invention, or the same composition of the present invention not containing the acrylic polymer additive, and the polymer alone in the absence of the acrylic polymer additive comprise a cylindrical pellet, preferably the cylindrical pellet has a cross-sectional diameter of greater than or equal to 0.1 mm and less than or equal to 3 mm, and a length of less than or equal to 3 mm. A cylindrical pellet having a length of 3 mm and a cross-sectional diameter of 3 mm is especially preferred.

Preferably, substantially all the moisture is removed from the composition of the present invention, the same composition of the present invention not containing the acrylic polymer additive, and the polymer alone in the absence of the acrylic polymer additive before measuring extensional and/or shear viscosities. Preferably, each of the compositions and the polymer alone is dried under vacuum, preferably at a temperature of 170° C., preferably from greater than or equal to 6 hours and less than or equal to 24 hours.

Preferably, when performing comparative measurements of extensional viscosity or shear viscosity, respectively, then these may be measured at substantially the same pressures.

Preferably, the maximum pressure exerted on the polymer alone in the absence of the acrylic polymer additive, the composition of the present invention, and the same composition of the present invention not containing the acrylic polymer additive is less than or equal to 30 Mpa, preferably less than or equal to 25 Mpa, preferably less than or equal to 20 Mpa, more preferably less than or equal to 15 Mpa.

Preferably, the maximum pressure exerted on the polymer alone in the absence of the acrylic polymer additive, the composition of the present invention and the same composition of the present invention not containing the acrylic polymer additive is greater than or equal to 0.5 Mpa, preferably greater than or equal to 1 Mpa, preferably greater than or equal to 3 Mpa, more preferably greater than or equal to 5 Mpa.

Suitably, it will be appreciated by those skilled in the art, that variables which may substantially effect extensional viscosity and shear viscosity measurements should preferably be substantially identical when performing comparative measurements.

All shear viscosity and extensional viscosity measurements may be obtained using a Rosand Capillary rheometer by methods well known to those skilled in the art as described herein.

It will be appreciated that the compositions of the present invention may exhibit both a decrease in shear viscosity and a decrease in extensional viscosity, particularly within the values as defined herein, compared to the polymer alone in the absence of the acrylic polymer additive and the composition of the present invention not containing the acrylic polymer additive when measured under substantially the same conditions as defined herein. Such compositions are also embraced by the scope of the present invention.

Preferably, the acrylic polymer additive is not a multi-stage polymer, particularly a multi-stage particulate polymer such as a core-shell polymer comprising a core polymer that is surrounded by or linked to a separate shell polymer e.g. an impact modifier particle. Suitably, the acrylic polymer additive is a linear or branched polymer. Preferably, the acrylic polymer additive is a linear polymer. Preferably, the acrylic polymer additive is thermoplastically processable.

Suitably, the acrylic polymer additive is amorphous. Preferably, the acrylic polymer additive is substantially immiscible with the polymer (e.g. polyolefin or polyamide). By the term “substantially immiscible” we, include that at the melt-processing temperatures when the composition of the present invention is molten, for example typically 190 to 310° C., the acrylic polymer additive forms a two-phase melt with the polymer. Microscopic examination of such a melt shows a two phase system in which the immiscible molten acrylic polymer is usually in the form of spherical particles or globules dispersed in a continuous molten polymer matrix.

Suitably, the composition of the present invention may be molten or in solid form, such as in the form of pellets, sheets, granules or powder. The pellets may be thermally processed for any downstream application. Preferably, when the composition of the present invention is in solid or molten form the polymer (i.e. polyolefin or polyamide) forms a polymer matrix with the acrylic polymer additive dispersed therein.

Suitably, the acrylic polymer additive in the composition of the present invention, particularly in the ultimate end product i.e. fibre, film or shaped article, may have a maximum cross-sectional dimension of less than or equal to 400 nm, more preferably less than or equal to 300 nm. Suitably, the acrylic polymer additive in the composition of the present invention, particularly in the ultimate end product i.e. fibre, film or shaped article, may have a maximum cross-sectional dimension of greater than or equal to 50 nm, more preferably greater than or equal to 75 nm. A particularly preferred maximum cross-sectional dimension of the acrylic polymer additive in the composition of the present invention, and in the ultimate end product, is 200 nm.

The size of the acrylic polymer additive in the composition of the present invention, such as its cross-sectional dimension, may be measured by techniques well known to those skilled in the art, for example, by scanning or transmission electron microscopy. In scanning electron microscopy, the composition of the present invention is frozen, typically in liquid nitrogen, and then fractured to expose the additive material whose size is measured by an electron microscope. In transmission electron microscopy, the composition of the present invention is frozen, typically in liquid nitrogen, and then pieces are shaved off for analysis with an electron microscope.

Preferably, the acrylic polymer additive does not include a liquid crystal polymer i.e. it does not form an anisotropic melt in the temperature range at which the thermoplastic polymeric mixture is melt-processed e.g. at a temperature of 190° C. to 330° C. as defined herein, after a shear stress is removed.

Preferably, the acrylic polymer additive includes less then 2% by weight of a styrene polymer. More preferably, the acrylic, polymer additive includes less than 1% by weight, most preferably less than 0.5% by weight, of a styrene polymer. Especially preferred acrylic polymer-additives do not include any styrene polymer.

The acrylic polymer additive suitably includes homopolymers and copolymers (which term includes polymers having more than two different repeat units), comprising monomers of acrylic acid and/or alkacrylic acid and/or alkyl(alk)acrylate. As used herein, the term “alkyl (alk)acrylate” refers to either the corresponding acrylate or alkacrylate ester, which are usually formed from the corresponding acrylic or alkacrylic acids. In other words, the term “alkyl (alk)acrylate” refers to either an alkyl alkacrylate or an alkyl acrylate.

Preferably, the alkyl (alk)acrylate is a (C₁-C₂₂)alkyl ((C₁-C₁₀)alk)acrylate. Examples of C₁-C₂₂ alkyl groups of the alkyl (alk)acrylates include methyl, ethyl, n-propyl, n-butyl, iso-butyl, tert-butyl, iso-propyl, pentyl, hexyl, cyclohexyl, 2-ethyl hexyl, heptyl, octyl, nonyl, decyl, isodecyl, undecyl, dodecyl, tridecyl, tetradecyl, pentadecyl, hexadecyl, heptadecyl, octadecyl, nonadecyl, eicosyl, behenyl, and isomers thereof. The alkyl group may be straight or branched chain. Preferably, the (C₁-C₂₂)alkyl group represents a (Cₗ-C₆)alkyl group as defined above, more preferably a (C₁-C₄)alkyl group as defined above. Examples of C₁-₁₀ alk groups of the alkyl (alk)acrylate include methyl, ethyl, n-propyl, iso-propyl, n-butyl, iso-butyl, tert-butyl, pentyl, hexyl, cyclohexyl, 2-ethyl hexyl, heptyl, octyl, nonyl, decyl and isomers thereof. The alk groups may be straight or branched chain.

Preferably, the (C₁-C₁₀)alk group represents a (C₁-C₆)alk group as defined above, more preferably a (C₁-C₄) alk group as defined above.

Preferably, the alkyl (alk)acrylate is a (C₁-C₄)alkyl ((C₁-C₄) alk)acrylate, most preferably a (C₁-C₄)alkyl (meth)acrylate. It will be appreciated that the term (C₁-C₄) alkyl (meth)acrylate refers to either (C₁-C₄)alkyl acrylate or (C₁-C₄)alkyl methacrylate. Examples of (C₁-C₄)alkyl (meth)acrylate include methyl methacrylate (MMA), ethyl methacrylate (EMA), n-propyl methacrylate (PMA), isopropyl methacrylate (IPMA), n-butyl methacrylate (BMA), isobutyl methacrylate (IBMA), tert-butyl methacrylate (TBMA), methyl acrylate (MA), ethyl acrylate (EA), n-propyl acrylate (PA), n-butyl acrylate (BA), isopropyl acrylate (IPA), isobutyl acrylate (IBA), tert-butyl acrylate (TBA), and combinations thereof.

Preferably, the alkacrylic acid monomer is a (C₁-C₁₀)alkacrylic acid. Examples of (C₁-C₁₀)alkacrylic acids include methacrylic acid, ethacrylic acid, n-propacrylic acid, iso-propacrylic acid, n-butacrylic acid, iso-butacrylic acid, tert-butacrylic acid, pentacrylic acid, hexacrylic acid, heptacrylic acid and isomers thereof. Preferably the (C₁-C₁₀)alkacrylic acid is a (C₁-C₄)alkacrylic acid, most preferably methacrylic acid.

Preferably, the acrylic polymer is an acrylic copolymer. Preferably, the acrylic copolymer comprises monomers derived from alkyl (alk)acrylate, and/or acrylic acid and/or alkacrylic acid as defined herein. Most preferably, the acrylic copolymer comprises monomers derived from alkyl (alk)acrylate, i.e. copolymerisable alkyl acrylate monomers and alkyl alkacrylate comonomers as defined herein. Especially preferred acrylic copolymers include a (C₁-C₄)alkyl acrylate monomer and a copolymerisable (C₁-C₄)alkyl (C₂-C₄)alkacrylate comonomer as defined herein. Most preferred acrylic copolymers are formed from a methyl methacrylate monomer and a copolymerisable (C₁-C₄)alkyl acrylate comonomer, particularly methyl acrylate and/or ethyl acrylate and/or butyl acrylate, especially ethyl acrylate or n-butyl acrylate.

Preferably, the acrylic copolymer comprises greater than or equal to 0.1% by weight, preferably greater than or equal to 0.5% by weight, more preferably greater than or equal to 1% by weight, even more preferably greater than or equal to 3% by weight of an alkyl acrylate monomer as defined herein based on the total weight of the acrylic copolymer. Preferably, the acrylic copolymer comprises less than or equal to 20%, preferably less than or equal to 17%, more preferably less than or equal to 15% by weight of an alkyl acrylate monomer as defined herein based on the total weight of the acrylic copolymer.

Preferably, the acrylic copolymer comprises less than or equal to 99.9% by weight, preferably less than or equal to 99.5% by weight, more preferably less than or equal to 99% by weight, even more preferably less than or equal to 97% by weight of a copolymerisable alkyl alkacrylate comonomer as defined herein, particularly methyl methacrylate, based on the total weight of the acrylic copolymer. Preferably, the acrylic copolymer comprises greater than or equal to 80%, preferably greater than or equal to 83%, more preferably greater than or equal to 85% by weight of a copolymerisable alkyl alkacrylate comonomer as defined herein, particularly methyl methacrylate, based on the total weight of the acrylic copolymer.

Preferably, the acrylic polymer comprises greater than or equal to 80 wt %, more preferably greater than or equal to 85 wt %, more preferably greater than or equal to 90 wt %, more preferably greater than or equal to 95 wt %, especially greater than or equal to 96 wt % methyl methacrylate based on the total weight of the acrylic polymer.

Preferably, the alkyl acrylate is a (C₁-C₄)alkyl acrylate, as defined herein. Most preferably, the alkyl acrylate is ethyl acrylate and/or butyl acrylate and isomers thereof.

Preferably, the acrylic copolymer comprises a homopolymer or copolymer derived from a monomer mixture comprising 80 to 100 wt % of methyl methacrylate, 0 to 20 wt % of at least one other copolymerisable alkyl (alk)acrylate comonomer, 0 to 0.5 wt % of an initiator, and 0 to 1.0 wt % of a chain transfer agent.

Preferably, where the acrylic polymer is an acrylic copolymer, particularly an acrylic copolymer including methyl methacrylate, the acrylic polymer comprises a single copolymerisable alkyl acrylate as defined herein, preferably a (C₁-C₄) alkyl acrylate, especially ethyl acrylate or butyl acrylate and isomers thereof. Preferably, the acrylic copolymer comprises 0.1 to 20% by weight of an alkyl acrylate monomer, particularly a (C₁-C₄) alkyl acrylate monomer, as defined herein and 80 to 99% by weight of a copolymerisable alkyl alkacrylate comonomer, particularly methyl methacrylate, as defined herein. More preferably, the acrylic copolymer comprises 1 to 15% by weight of an alkyl acrylate monomer, is particularly a (C₁-C₄) alkyl acrylate monomer, and 85 to 99% by weight of copolymerisable methyl methacrylate comonomer. Especially preferred acrylic copolymers comprise 3 to 15% by weight of an alkyl acrylate monomer, particularly a (C₁-C₄) alkyl acrylate monomer, as defined herein, particularly ethyl acrylate or butyl acrylate, and 97 to 85% by weight of copolymerisable methyl methacrylate comonomer.

Highly preferred acrylic copolymers include 1.75%, 3%, 4%, 10% and 15% by weight of an alkyl acrylate monomer, particularly ethyl acrylate or n-butyl acrylate, based on the total weight of the acrylic copolymer, and 98.25%, 97%, 96%, 90% and 85% by weight respectively of methyl methacrylate comonomer based on the total weight of the acrylic copolymer.

Suitably, where the acrylic polymer is a copolymer derived from a monomer mixture of at least one alkyl alkacrylate monomer as defined herein, particularly methyl methacrylate, and at least one other copolymerisable alkyl acrylate comonomer as defined herein, particularly ethyl and/or butyl acrylate, the ratio of the weight of alkyl alkacrylate to the weight of alkyl acrylate in the acrylic copolymer is suitably greater than or equal to 4:1, preferably greater than or equal to 5:1, preferably greater than or equal to 6:1, preferably greater than or equal to 8:1, preferably greater than or equal to 10:1, more preferably greater than or equal to 15:1, more preferably greater than or equal to 19:1.

Unexpectedly, it has been found that if the molecular weight of the acrylic polymer additive as defined herein is below a threshold value then the composition of the present invention may exhibit the desired decrease in extensional viscosity and/or shear viscosity.

Preferably, the acrylic polymer has a weight average molecular weight/greater than 50,000, more preferably greater than 75,000, most preferably greater than 80,000.

Preferably the acrylic polymer has a weight average molecular weight less than 300,000, preferably less than 200,000, most preferably less than 150,000. An acrylic polymer having a weight average molecular weight in the range of approximately 85,000 to 150,000 is especially preferred. Suitably, the weight average molecular weight of the acrylic polymer may be measured by techniques well known to those skilled in the art, such as gel permeation chromatography.

The acrylic polymer may be synthesised by techniques well known to those skilled in the art, such as suspension polymerisation as outlined in Kirk-Othmer Encyclopaedia of Chemical Technology, John Wiley and Sons. Vol. 16 p.506-537, particularly p.525-727. Suitably, the suspension polymerisation method involves the polymerisation of one or more monomers of acrylic acid, alkacrylic acid or alkyl (alk)acrylate as defined herein in the presence of one or more initiators-and one or more chain transfer agents. Suitable initiators include free radical initiators such as peroxy, hydroperoxy and azo initiators, for example, 2,2′-azo-bis (isobutyronitrile) (AIBN), 2,2′-azo-bis(2,4-dimethylvaleronitrile), azo-bis(α-methylbutyronitrile), acetyl peroxide, dodecyl peroxide, benzoyl peroxide. Preferably, the acrylic polymer includes at least 0.01 wt %, more preferably at least 0.02 wt %, most.preferably at least 0.04 wt % initiator based on the total weight of the acrylic polymer. Preferably, the acrylic polymer includes less than 0.5 wt %, more preferably less than 0.3 wt %, most preferably less than 0.25 wt % initiator based on the total weight of the acrylic polymer.

Suitable chain transfer agents include thiols, such as dodecyl mercaptan, n-propyl mercaptan, n-butyl mercaptan, t-butyl mercaptan, 2-ethyl hexyl thioglycollate, thiophenol and butanthiol. Preferably, the acrylic polymer includes at least 0.03 wt %, preferably at least 0.05 wt %, preferably at least 0.8 wt %, preferably at least 0.1 wt %, most preferably at least 0.15 wt % chain transfer agent based on the total weight of the acrylic polymer. Preferably, the acrylic polymer includes less than 1 wt %, preferably less than 0.9 wt %, preferably less than 0.8 wt %, preferably less than 0.7 wt %, preferably less than 0.6 wt %, most preferably less than 0.5 wt % chain transfer agent based on the total weight of the acrylic polymer.

Preferably, the molar ratio of initiator to chain transfer agent employed in the polymerisation process is less than or equal to 11:1, preferably less than or equal to 8:1, preferably less than or equal to 7:1, more preferably less than or equal to 6:1, more preferably less than or equal to 5:1, most preferably less than or equal to 4:1.

Preferably, the molar ratio of chain transfer agent to initiator employed in the polymerisation process is preferably greater than or equal to 1:1, preferably greater than or equal to 1.5:1, more preferably greater than or equal to 2:1.

An especially preferred range of the molar ratio of chain transfer agent to initiator employed in the polymerisation process is greater than or equal to 1:1 and less than or equal to 2.5:1.

Suitably, the acrylic polymer may include the aforementioned molar ratios of initiator to change transfer agents.

Suitably, the polymer (e.g. the polymer matrix) of the composition of the present invention includes a polymer comprising a polyamide and/or polyolefin. Preferably, the polyamide is thermoplastically processable. Preferably, the polyolefin is thermoplastically processable. As mentioned previously, the polymer in the molten composition of the present invention typically forms a molten polymer matrix in which the acrylic polymer additive as defined herein is dispersed.

When a polyamide is used, the polyamide may include homopolymers or copolymers synthesised by polycondensation of an aliphatic or aromatic diamine such as hexamethylene diamine, nonamethylene diamine and m-xylene diamine with an aliphatic or aromatic dicarboxylic acid such as adipic acid, sebacic acid and terephthalic acid, or they may be synthesised from polymerisation of a lactam such as ε-caprolactam and ω-lauro lactam or from the self-polycondensation of amino acids such as ε-aminocaproic acid and 11-aminoundecanoic acid. Preferably the polyamide includes nylon-6,6 (polyhexamethylene adipimide), nylon-6 (poly-ε-caprolactam), nylon-11, nylon-6,10 (polyhexamethylene sebacamide) and copolymers thereof. The homopolymers are preferred. However, copolymers are also included within the scope of the present invention. When the polyamide comprises a copolymer then copolymers formed by copolymerising a polyamide monomer, such as nylon-6,6, with at least one other, preferably only one other, copolymerisable polyamide comonomer e.g. nylon-6, are preferred. Preferably, when the polyamide is a copolymer, the copolymer is formed by copolymerising a polyamide monomer with only a copolymerisable polyamide comonomer suitably, preferred copolymers do not include composite resins such as poly(amide-polyester) resins. For example, we include nylon-6,6/nylon-6 and nylon-6,6/nylon-6TA, where 6TA represents a hexamethylene terephthalamide unit. Among these polyamides homopolymers of nylon-6 and nylon-6,6 are especially preferred.

When a polyolefin is used, the polyolefin may be derived by polymerising at least one mono-alpha olefin monomer, preferably at least one mono-alkene monomer i.e. an alkene having a single double bond. Preferably, the at least one mono-alkene monomer comprises a C₂-C₈ alkene, especially a linear or branched (i.e. non-aromatic, cyclic or heterocyclic) C₂-C₈ alkene monomer, such as ethene, propene, but-1-ene, 2-methyl-propene (isobutene), pent-1-ene, pent-2-ene, 3-methyl-pent-1-ene, 2-methyl-but-1-ene, 4-methyl-pent-1-ene, 3-methyl-but-1-ene, 4-methyl-pent-2-ene, hex-1-ene, hex-2-ene and hex-3-ene. Preferred C₂-C₈ alkene monomers include ethene, propene, but-1-ene, 2-methyl-propene, 3-methyl-but-1-ene and 4-methyl-1-pent-1-ene. Especially preferred C₂-C₈ alkene monomers include ethene, propene and but-1-ene.

Preferred polyolefins are homopolymers derived from polymerising one mono-alkene monomer, particularly a C₂-C₈ alkene monomer, as defined herein. Preferred homopolymers include polyethylene, such as low-density polyethylene, high-density polyethylene and linear low-density polyethylene, polypropylene, and homopolymers derived from polymerising 2-methyl-propene monomers, 3-methyl-but-1-ene monomers and 4-methyl-pent-1-ene monomers. Especially preferred homopolymers include polyethylene and polypropylene.

Although less preferred, copolymers of polyolefins are also included within the scope of the present invention. Preferred copolymers are derived from copolymerising a mono-alkene monomer, particularly a linear or branched C₂-C₈ alkene monomer, as defined herein with at least one other, preferably only one, copolymerisable linear or branched C₂-C₈ alkene comonomer. Preferably, when the polyolefin is a copolymer, the copolymer is formed by copolymerising a polyolefin monomer with only a copolymerisable polyolefin comonomer. Suitably, preferred copolymers do not include composite resins such as poly(styrene-ethylene) polymers. Preferred copolymers include poly(ethylene-propylene), poly(propylene-but-1-ene) and poly(ethylene-oct-1-ene).

Preferred compositions of the present invention include: nylon and an acrylic polymer additive; polyethylene and an acrylic polymer additive; and, polypropylene and an acrylic polymer additive.

The polyamide or polyolefins may comprise one or more agents selected from a glass filler, mineral filler, flame retardant, UV stabiliser, delustering agent, a thermal stabilizer, an ultraviolet absorber, an antistatic agent, a terminating agent and a fluorescent whitening agent, or a mixture of two or more of these agents.

Preferably, the acrylic polymer additive is present in an amount of at least 0.1 wt %, more preferably at least 0.25 wt %, even more preferably at least 0.5 wt %, most preferably greater than or equal to 1 wt % based on the total weight of the composition of the present invention.

Preferably, the acrylic polymer additive is present in an amount of less than or equal to 20 wt %, preferably less than or equal to 15 wt %, more preferably less than or equal to 12 wt %, most preferably less than or equal to 5 wt % based on the total weight of the composition of the present invention.

The addition of such low amounts of acrylic polymer may further reduce the costs of the overall process, thereby allowing significant increases in productivity to be achieved. However, it will be appreciated that the acrylic polymer additive may be added to the polymer matrix in an amount of greater than 10 wt % of the polymer matrix if desired.

Preferably, the amount of polymer (i.e. polyolefin or polyamide) in the composition of the present invention is greater than or equal to 80 wt %, preferably greater than or equal to 85 wt %, more preferably greater than or equal to 88 wt %, most preferably greater than or equal to 95 wt % based on the total weight of the composition of the present invention.

Preferably, the amount of polymer (i.e. polyolefin or polyamide) in the composition of the present invention is less than or equal to 99.9 wt %, preferably less than or equal to 99.75 wt %, more preferably less than or equal to 99.5 wt %, most preferably greater than or equal to 99 wt % based on the total weight of the composition of the present invention.

Preferably, the amount of additive that is added to the polymer should be kept as low as possible to achieve the desired decrease in extensional viscosity and/or shear viscosity whilst maintaining the physical properties i.e. thermal stability, substantially similar to that of the unmodified polymer.

It will be appreciated by those skilled in the art, as exemplified by the specific non-limiting examples as described hereinafter, that the amount of decrease in the extensional viscosity and/or the shear viscosity of the composition of the present invention compared with the same composition not containing the acrylic polymer additive, particularly the polymer alone, may be dependent, amongst other things, on the amount of acrylic polymer additive added, average molecular weight of the acrylic polymer additive, and the type of acrylic polymer additive. Consequently, by routine experimentation it is usually possible to produce a composition of the present invention having the desired decrease in extensional viscosity and/or shear viscosity for the particular is application e.g. high-speed spinning, whilst maintaining the physical properties of the composition of the present invention substantially similar to that of the same composition, particularly the polymer alone, in the absence of the additive.

The acrylic polymer additive may be incorporated into a polymer as defined herein by various methods. For example, the addition of the additive may be effected during the polymerisation process for forming the polymer. Alternatively, the additive may be melt-blended with the polymer. For example, the acrylic polymer additive may be compounded with the polymer to form a pellet which is subsequently extruded and processed for example moulded into an article. Furthermore, the additive may be mixed with the polymer in the hopper of an extruder and the resultant mixture extruded and processed. Alternatively, a melt stream of the additive may be added to a melt stream of the polymer, by a side extrusion or injection process.

Preferably, the acrylic polymer additive is melt-blended with the polymer employing the above methods at a temperature between 150° C. to 300° C. preferably 170° C. to 290° C., more preferably 160° C. to 240° C. when the polymer comprises a polyolefin and 260° C. to 290° C. when the polymer comprises a polyamide.

Most preferably, non-molten acrylic polymer additive is added to a melt stream of the polymer by a cramming process. By adding non-molten acrylic polymer additive to such a melt stream, enables the polymeric composition of the present invention to be easily controlled and/or varied during the production process. The adaptability of the production equipment may result in significant cost savings and enhanced productivity, particularly if it is necessary to vary the polymeric composition of the present invention. Moreover, this type of addition process may minimise the exposure of the acrylic polymer additive to the high temperature polymer processing conditions, thereby forming a more stable polymer mixture.

According to a second aspect, the present invention provides a method of making a composition of the present invention as defined herein comprising providing a polymer selected from a polyamide and/or polyolefin as defined herein, and adding an acrylic polymer additive as defined herein to the polymer. It will be appreciated that any of the aforementioned methods of adding the additive to the polymer may be employed. Preferably, the acrylic polymer additive is melt-blended with the polymer. Preferably, non-molten acrylic polymer additive is added to the molten polymer.

According to a third aspect, the present invention provides a use of the composition of the present invention to form a fibre. Preferably, the process for producing a polymeric fibre comprise providing a molten composition of the present invention as defined herein, and forming a fibre from the molten composition of the present invention.

Preferably, the molten composition of the present invention is formed by adding non-molten acrylic polymer additive to the molten polymer.

Preferably, the production of the polymeric fibre is accomplished by high speed spinning using spinning devices which are known per se. Preferably, spinning speeds of greater than or equal to 500 m/minute, more preferably greater than or equal to 2000 m/minute, most preferably 3000 m/minute are employed. Preferably, the spinning speed is less than or equal to 10000 m/minute, more preferably less than or equal to 7500 m/minute, most preferably less than or equal to 6000 m/minute.

According to a fourth aspect the invention provides a fibre comprising the composition of the present invention.

The non-molten acrylic polymer additive may be added at various points in the spin line. If the spin line does not include an extruder, i.e. the molten polymer is fed to a set of static and/or dynamic mixers upstream of a spinneret by booster pumps, then preferably the non-molten acrylic polymer additive is added to the molten polymer stream at a point immediately before the molten polymer reaches the static and/or dynamic mixers. Suitably, such a point of addition minimises the exposure of the acrylic polymer additive to the high temperature polymer processing conditions whilst enabling the acrylic polymer additive to be adequately mixed with the molten polymer.

It will be appreciated that the non-molten acrylic polymer additive may be added to the molten polymer stream at any point between the booster pumps and the static and/or dynamic mixers. Alternatively, the non-molten acrylic polymer additive may be added to the molten polymer stream in the booster pumps or at a point upstream of the booster pumps, i.e. at a point before the polymer stream reaches the booster pumps.

If the spin line includes an extruder, as opposed to booster pumps, then the non-molten acrylic polymer additive may be added to the screw section of the extruder. Alternatively, the non-molten acrylic polymer additive may be added immediately downstream of the extruder i.e. at or just beyond the tip of the screw, so that pressure carries the additive forward with the molten polymer stream. Alternatively, the non-molten acrylic polymer additive may be added downstream of the extruder at a point immediately prior to the molten polymer stream reaching a set of static mixers and/or dynamic mixers. Such a point of addition may further minimise the exposure of the acrylic polymer additive to the high temperature processing conditions. Preferably, the non-molten acrylic polymer additive is added to the screw section of the extruder. Most preferably, at a point of the screw section of the extruder where the polymer (polyolefin or polyamide) melts in the extruder. Such a point of addition usually ensures that the additive is subjected to adequate shear forces so that droplets form prior to emerging from the spinneret whilst minimising the exposure of the additive to the high temperature processing conditions.

Preferably, the non-molten acrylic polymer additive is added to the molten polymer (i.e. polyamide or polyolefin) by a crammer such as a twin-screw crammer, model ZS-B25, supplied by Werner & Pfleiderer or a twin-screw crammer, model R17, supplied by St\overline{6}ber.

It will be appreciated by those skilled in the art that various combinations of the above points of addition for adding the non-molten acrylic polymer additive to the polymer melt are embraced by the present invention. Moreover, the non-molten acrylic polymer additive may be replaced totally or partially by a molten acrylic polymer additive as defined hereinbefore.

The acrylic polymer additive is preferably homogeneously distributed in the molten polymer (i.e. polyamide or polyolefin) by mixing in the extruder and/or by means of the static and/or dynamic mixers in the distribution manifold and/or in the spin pack. Suitably, varying the point of addition of the acrylic polymer additive enables the user to vary the type and extent of mixing of the additive with the molten polymer. Suitably, this enables the user to vary the rheology of the acrylic polymer and thereby control the particle size distribution of the acrylic polymer in the composition of the present invention before the composition of the present invention passes through the spinneret.

Preferably, the droplet size of the acrylic polymer additive emerging from the spinneret is approximately 75 to 400 nm, most preferably 200 nm.

The composition of the present invention may be made in the form of sheets, film, powders or granules. It may be extruded or moulded into various shapes or coextruded or laminated onto other materials, rigid or foamed forms of ABS, PVC, polystyrene polymers including high impact polystyrene (HIPS). It may also be coextruded or laminated onto metals. When the composition of the present invention is in the form of sheets it may be thermoformed into a desired shape.

According to a fifth aspect, the present invention provides a shaped article comprising the composition of the present invention. Suitably, said shaped article may be formed by extrusion, by moulding such as blow-moulding or injection-moulding, thermoforming or coextruded or laminated onto other materials.

Said shaped article may be for use in construction of a building. For example, it could be a solid or coextruded building component, for example a soffit board, barge board, fascia board, cladding board, siding, gutter, pipe, shutters, window casement, window board, window profile, conservatory profile, door panels, door casement, roofing panel, architectural accessory or the like.

Said shaped article may be for use in constructing a vehicle or in another automotive application, both as a bulk material or as a coextruded laminate. Such applications, include but are not limited to, decorative exterior trim, cab mouldings, bumpers (fenders), louvers, rear panels, accessories for buses, trucks, vans, campers, farm vehicles and mass transit vehicles, side and quarter panel trim or the like.

Said shaped article may be used in applications both indoors or outdoors, for example bathroom fixtures, toilet seat, kitchen housewares, bottles, containers, refrigerator liners or bodies, fencing, trash cans, garden furniture or the like.

According to a sixth aspect, the present invention provides a use of the composition of the present invention to form a shaped article.

According to a seventh aspect, the present invention provides a film comprising the composition of the present invention. Suitably, the film may be formed by blow-moulding or extruding the composition of the present invention. Typically, the film has a thickness of 10 microns to 2 mm.

According to an eighth aspect, the present invention provides a use of the composition of the present invention to form a film.

According to a ninth aspect the present invention provides the use of an acrylic polymer additive as defined herein for decreasing the extensional viscosity and/or the shear viscosity of a polymer, particularly a polyamide or polyolefin, as defined herein. Suitably, such use may be affected by admixing the acrylic polymer additive as defined herein with a polyamide or polyolefin by the methods described herein.

Suitably, features of the first, second, third, fourth, fifth, sixth, seventh, eighth and ninth aspects of the present invention may be combined and regarded as preferred features of the other aspects of the present invention.

The invention will be further described by way of the following non-limiting examples with reference to the accompanying drawings, wherein:

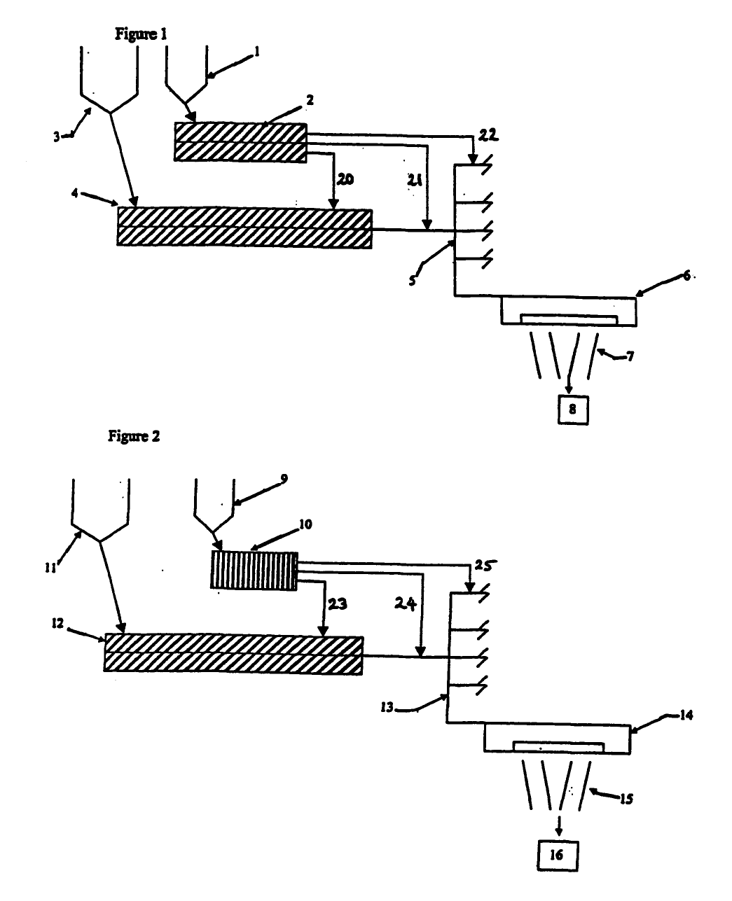

FIG. 1 is a flow diagram representing a spin line for producing a polymeric fibre by incorporating molten acrylic polymer additive as defined hereinbefore into a melt stream of a polymer as defined hereinbefore; and

FIG. 2 is a flow diagram representing a spin line for producing a polymeric fibre by incorporating non-molten acrylic polymer additive as defined hereinbefore into a melt stream of a polymer as defined hereinbefore.

For simplicity, the following description in part refers to polyolefins only. However, it will be appreciated that the term “polyolefin” is interchangeable with the term “polymer” as defined herein.

There is shown in FIG. 1 apparatus for adding a molten acrylic polymer additive to a melt stream of polyolefin comprising a hopper (1) for receiving the acrylic polymer additive and an extruder (2) for extruding the acrylic polymer additive from the hopper (1). The apparatus further comprises a separate hopper (3) for receiving the polyolefin polymer and an extruder (4) for extruding the polyolefin polymer from the hopper (3). The extruder (4) feeds into a tubular manifold system (5) containing static mixers. The tubular manifold system (5) feeds into a spin pack and spinneret (6). The spinneret comprises a plate having typically more than 20 holes each having a diameter of about 0.3 mm.

In use, the hoppers (1) and (3) are charged with dry base chips of the acrylic polymer additive and polyolefin polymer, respectively. The extruders (2) and (4) extrude the acrylic polymer additive and polyolefin from the hoppers (1 and 2) to form separate melt flows of the two polymers. The molten acrylic polymer additive is added to the melt flow of the polyolefin polymer. This may take place in the screw of the extruder (4) as indicated by line 20, and/or at a point immediately downstream of the extruder (i.e. at or just beyond the tip of the screw) as indicated by line 21, and/or at a point immediately upstream of the static mixers as indicated by line 22. It will be appreciated that a combination of the above points of addition may be employed. Moreover, the molten acrylic polymer additive may be added to the molten polyolefin polymer at any point along the manifold system (5) before the pack and spinneret (6). The polymer mixture is mixed by the static mixers of the manifold system (5) and then metered to the spin pack and spinneret (6). The spin pack is filled with shattered metal and produces very high shear so that filaments (7) of the polymeric mixture emerge from the spinneret. The filaments (7) are forwarded to an appropriate take-up station (8) well known to those skilled in the art which may include various finishing and packaging steps.

There is shown in FIG. 2 apparatus for adding non-molten acrylic polymer additive to a melt stream of a polyolefin polymer comprising a hopper (11) for receiving the polymer and an extruder (12) for forming a melt stream of the polyolefin polymer. The extruder (12) terminates in a tubular manifold (13) having static mixers contained therein. The tubular manifold (13) feeds into a spin pack and spinneret (14) as described above for the apparatus of FIG. 1. The apparatus further comprises a separate hopper (9) for receiving the acrylic polymer additive and a crammer (10), such as that supplied by St\overline{6}ber, for delivering non-molten acrylic polymer additive to the polymer melt flow.

In use, the hoppers (11) and (9) are charged with dry base chips of polyolefin polymer and acrylic polymer respectively. The extruder (12) extrudes the polyolefin polymer from the hopper (11) to produce a melt flow. The crammer (10) conveys the non-molten acrylic polymer into the polyolefin melt stream. The crammer does not include a separate heat source so that it does not melt the acrylic polymer. Optionally, the crammer may include a cooling apparatus. The non-molten acrylic polymer may be added to the screw of the extruder (12) as indicated by line 23, and/or at a point immediately downstream of the extruder (i.e. at or just beyond the tip of the screw) as indicated by line 24, and/or at a point immediately upstream of the static mixers in the tubular manifold (13) as indicated by line 25. In general, the non-molten acrylic polymer can be added at any point along the tubular manifold system (13) before the spin pack and spinneret (14). If the acrylic polymer is added to the screw of the extruder (12) then preferably the additive crammer (10) is situated opposite an additive injector, if one is fitted. As before, the filaments (15) are forwarded to an appropriate take-up system (16) which may include various finishing and packaging steps.

It will be appreciated by those skilled in the art that one or all of the extruders (4 and 12) of the apparatus of FIGS. 1 and 2 may be replaced by booster pumps, if the system is fed with a polymer melt, for example from a continuous polymerisation process.

Rheological Analysis

Viscosity measurements were made using a Rosand Capillary rheometer at a temperature of between 190° C. to 310° C. Shear viscosity measurements were made at shear rates of between 30 s⁻¹ and 10,000 s⁻¹, and elongational extensional viscosities calculated from these data as outlined below. The thermal stability of the composition and the additives was assessed by monitoring the viscosity over 1800 s.

In the capillary rheometry analysis, the polymer chip (i.e. the polymer composition or the additive) is heated to the desired temperature (i.e. melted) and simultaneously extruded through two barrels: one barrel containing an elongated die (16 mm in length) and 1 mm in 30 diameter; and, the other barrel containing an orifice die (0.2 mm in length) and 1 mm in diameter. Pressure transducers are located upstream of each of the respective die entry regions to record the pressure drop through each die for an individual shear rate i.e. ram speed. Two parallel measurements are made to allow for die entry correction to be made. For both dies (i.e. elongated and orifice die) a contribution to the total pressure drop recorded is attributed to the resistance of the polymer melt converging in the die entry region (which is analogous to stretching a unit cell of molten polymer i.e. extensional viscosity). A further contribution to the pressure drop occurs with the elongated die but not the orifice die, which is attributable to the resistance to flow of the polymer melt due to shear with the die walls.

Consequently, the pressure drop recorded through the orifice die relates to the extensional viscosity of the polymer melt, as no shear occurs at the die walls unlike in the elongated die having die walls. Similarly, the difference in the pressure drop between the elongated die and the orifice type die produces a measure of the shear viscosity of the polymer melt.

The deformation and flow of a polymer system is generally carried out in shear for measurement convenience and related as shear viscosity (η), shear rate (γ) or shear stress (T). The elongational viscosity (λ) is then calculated by the software in the rheometer in accordance with Cogswell's equation:

$$λ = {{\frac{9}{32} [ \frac{n + 1}{η} ]}^{2} [ \frac{{p}_{o}}{γ} ]}^{2}$$

where η represents shear viscosity, n represents the shear thinning exponent, γ represents shear strain and Pₒ represents the extrapolated zero length die pressure drop.

### EXAMPLE 1

Preparation of an acrylic copolymer additive comprising 98.25% by weight methyl methacrylate and 1.75% by weight ethyl ethylacrylate by suspension polymerisation.

A 5 litre round bottom flask with four baffles in the flask walls and equipped with a shaft driven paddle stirrer passing down an alembic condenser is charged with 28 g disodium hydrogen phosphate, dihydrate, 2000 g deionised water, and 100 g of 1% sodium polymethacrylate (high molecular weight polymethylacrylate, neutralised with NaOH) solution in water. The suspension is heated to 40° C. to 50° C. with stirring to dissolve the sodium polymethacrylate, and nitrogen is bubbled through the solution for 30 minutes to remove oxygen. The nitrogen purge is stopped and 1080 g methyl methacrylate, 19.25 g ethyl acrylate, 2.50 g 2,2′-azobis(isobutyronitrile) (AIBN) and 3.40 g dodecyl mercaptan are then charged to the reaction flask. A nitrogen blanket is maintained over the reactants. The reaction mixture is heated to the reaction temperature of 82° C. and maintained while the reaction proceeds. The stirrer speed may need to be increased during the reaction exotherm which can push the temperature up to ca. 95° C. and water may need to be added if the batch foams excessively. After the exotherm begins to subside the bath is heat-treated to reduce residual monomer levels and decompose any residual initiator by heating at 90° C. for 1 hour. The reaction mixture is cooled and then centrifugally washed by pouring the reaction slurry into a centrifuge bag, dewatering and washing with 2×2 litres deionised water, with dewatering between each addition. The centrifuge bags have a pore size of ca. 75 microns. The filtered and washed polymer is spread onto trays and dried in an air oven at a temperature of 75° C. for 24 hours, to yield the title acrylic copolymer having a weight average molecular weight of 98,000 measured by gel permeation chromatography.

The acrylic copolymer had a melt flow index MFI (ASTM D1238, 230° C., 3.8 kg) of 2.3 g/10 minutes, a viscosity number 56 ccm/g (measured as a 0.5% solution in chloroform).

### EXAMPLE 2

Preparation of an acrylic copolymer additive comprising 99.5% by weight methyl methacrylate and 0.5% by weight ethyl acrylate by bag polymerisation.

The following materials were thoroughly mixed in a 10 litre glass round bottomed flask using a shaft driven paddle stirrer passing down an alembic condenser:

4923.30 g methyl methacrylate

24.70 g ethyl acrylate

2.40 g lauryl peroxide

0.54 g t-butyl peroxyacetate (50% active)

23.09 g dodecyl mercaptan

0.73 g oxalic acid solution (7.16% w/w in water)

0.91 g 75% w/w sodium dioctyl sulphosuccinate in ethanol/ water (AOT 75)

4.95 g dithio-bis-stearylpropionate

19.80 g stearyl methacrylate

The reaction mixture is stirred and the flask purged with nitrogen for 30 minutes. The monomer mixtures produced are charged into a nylon 6,6 (or nylon 6) polymer bag having a wall thickness less than 0.8 mm for polymerisation. The bag is similar in appearance to a plastic trash bag with dimensions sufficient to accommodate the monomer mixture and yield a bag thickness of no more than 3 cm. The bag is placed on a metal tray and filled with the monomer mixture. Trapped air is removed and the bag sealed with a metal clip. The tray and bag are placed in a suitably designed oven and the oven temperature controlled as detailed in the table below:

| Step | Temperature | Time | |
|---|---|---|---|
| 1 | 63° C. | 1.5 | h |
| 2 | 58° C. | 13.5 | hr |
| 3 | 62° C. | 1 | h |
| 4 | 65° C. | 2 | h |
| 5 | 75° C. | 1 | h |
| 6 | 100° C. | 1 | h |
| 7 | 130° C. | 2 | h |

This profile achieved a conversion, level of >98% and produced a bulk polymer of very smooth appearance with no irregularities or “hot spots” at the surface. The nylon bag was removed to yield the title acrylic copolymer having a weight average molecular weight of 77,000.

### EXAMPLE 3

Preparation of an acrylic copolymer additive comprising 90% by weight methyl methacrylate and 10% by weight n-butyl acrylate by suspension polymerisation.

The title copolymer additive is prepared by the experimental methodology as outlined in Example 1 employing the following reactants.

28.0 g disodium hydrogen phosphate dihydrate

2000 g deionised water

100 g 1% sodium polymethacrylate (high molecular weight polymethylacrylate, neutralised with NaOH) in water

990 g methyl methacrylate

110 g n-butyl acrylate

2.5 g 2,2′-azobis(isobutyronitrile) AIBN

3.5 g dodecyl mercaptan

The title acrylic copolymer additive was found to have a weight average molecular weight of 86,000 by gel permeation chromatography.

### EXAMPLE 4

Preparation of an acrylic copolymer additive comprising 96% by weight methyl methacrylate and 4% by weight ethyl acrylate by suspension polymerisation.

The title acrylic copolymer additive is prepared by the experimental methodology as outlined in Example 1 employing the following reactants.

28.0 g disodium hydrogen phosphate dihydrate

2000 g deionised water

100 g 1% sodium polymethacrylate (high molecular weight polymethylacrylate, neutralised with NaOH) in water

1056 g methyl methacrylate

44 g ethyl acrylate

2.5 g 2,2′-azobis(isobutyronitrile) AIBM

4.0 g dodecyl mercaptan

The title acrylate copolymer additive was found to have a weight average molecular weight of 85,000 by gel permeation chromatography.

### EXAMPLE 5

Preparation of an acrylic copolymer additive comprising 85% by weight methyl methacrylate and 15% by weight n-butyl acrylate by suspension polymerisation.

The title acrylic copolymer additive is prepared by the experimental methodology as outlined in Example 1 employing the following reactants:

30.8 g disodium hydrogen phosphate dihydrate

2000 g deionised water

100 g 1% sodium polymethacrylate (high molecular weight polymethylacrylate, neutralised with NaOH) in water

765 g methyl methacrylate

135 g n-butyl acrylate

2.0 g 2,2′-azobis(isobutyronitrile) AIBN

3.0 g dodecyl mercaptan

The title acrylic copolymer additive was found to have a weight average molecular weight of 85,000 by gel permeation chromatography.

### EXAMPLE 6

Preparation of an acrylic copolymer additive comprising 97% by weight methyl methacrylate and 3% by weight ethyl acrylate by suspension polymerisation.

The title acrylic copolymer additive is prepared by the experimental methodology as outlined in Example 1 employing the following reactants.

28.0 g disodium hydrogen phosphate dihydrate

2000 g deionised water

100 g 1% sodium polymethacrylate (high molecular weight polymethylacrylate, neutralised with NaOH) in water

1067 g methyl methacrylate

33 g ethyl acrylate

2.5 g 2,2′-azobis(isobutyronitrile) AIBN

2.0 g dodecyl mercaptan

The title acrylate copolymer additive was found to have a weight average molecular weight of 136,000 by gel permeation chromatography.

### EXAMPLE 7

General Procedure for Preparing a Composition of the Present Invention

A mixture comprising the desired pelletised polymer (e.g. polyamide or polyolefin) and a pelletised acrylic polymer additive is fed to a twin screw extruder having a screw designed to compound a polyamide or polyolefin, respectively, such as a ZSK30 twin screw extruder by Werner Pfleiderer, running at 270° C. when the polymer comprises a polyamide and running at 230° C. when the polymer comprises polypropylene, with a screw speed of 275 revolutions per minute and an output from the extruder of 15 kg/hour. The composition of the present invention exiting the extruder is cooled in a water bath prior to pelletisation using a rotary hall/cutter unit.

Using the above procedure the following compositions were prepared:

Composition 1: 99% by weight polyamide-6,6 (extrusion grade Zytel E50 available from DuPont) 1% by weight acrylic. copolymer additive of Example 4 comprising 96% by weight methyl methacrylate and 4% by weight 20 ethyl acrylate (referred to as 4% EA).

Composition 2: 99% by weight polypropylene [of melt flow index 3.5 (230° C., 2.16 kg,g/10 minutes) ISO 1133]. 1% by weight acrylic copolymer additive of Example 5 comprising 85% by weight methyl methacrylate and 15% by weight n-butyl acrylate (referred to as 15% nBA).

Composition 3: 99% by weight polypropylene [of melt flow index 3.5 (230° C., 2.16 kg,g/10 minutes) ISO 1133]. 1% by weight acrylic copolymer additive of Example 3 comprising 90% by weight methyl methacrylate and 10% by weight n-butyl acrylate (referred to as 10% nBA)

Composition 4: 99% by weight polypropylene [of melt flow index 3.5 (230° C., 2.16 kg,g/10 minutes) ISO 1133]. 1% by weight acrylic copolymer additive of Example 1 comprising 98.75% by weight methyl methacrylate and 1.75% by weight ethyl acrylate (referred to as 1.75% EA).

Composition 5: 99% by weight polypropylene [of melt flow index 3.5 (230° C., 2.16 kg,g/10 minutes) ISO 1133]. 1% by weight acrylic copolymer additive of Example 6 comprising 97% by weight methyl methacrylate and 3% by weight ethyl acrylate (referred to as 3% EA).

### EXAMPLE 8

Rheological Measurements of Composition 1

The shear viscosities and extensional viscosities of: (1) polyamide-6,6 (extrusion grade Zytel ESO available from DuPont) in the absence of an acrylic copolymer additive; and (2) composition 1 as outlined in Example 7, was determined at 290° C.

In all experiments the shear viscosity and the extensional viscosity of the polymeric composition and polyamide-6,6 were measured at an initial shear rate of 10,000 s⁻¹.

Further measurements of extensional viscosity and shear viscosity were made at the specified shear rates by decreasing the shear rate from 10000 s⁻¹ to 6000 s⁻¹, then to 3000 s⁻¹, then to 1500 s⁻¹, then to 1000 s⁻¹, then to 500 s⁻¹, then to 300 s⁻¹, then to 100 s⁻¹, then to 60 s⁻¹, and finally to 30 s⁻¹.

The results are tabulated in Table 1 and demonstrate that the polymeric composition of the present invention exhibits decreased extensional and decreased shear viscosity compared with the polymer alone in the absence of the acrylic polymer additive. Typically, this may lead to an overall increase in the productivity of a spinning, moulding or film forming process.

### EXAMPLE 9

Rheological Measurements of Compositions 2 to 5

The shear viscosities and extensional viscosities of: (1) polypropylene [of melt flow index 3.5 (230° C., 2.16 kg,g/10 minutes) ISO 1133]; (2) composition 2 as outlined in Example 7; (3) composition 3 as outlined in Example 7; (4) composition 4 as outlined in Example 7; and. (5) composition 5 as outlined in Example 7 were determined at 230° C.

In all experiments the shear viscosity and the extensional viscosity of the polymeric compositions and polypropylene were measured at an initial shear rate of 10,000 s⁻¹. Further measurements of extensional viscosity and shear viscosity were made at the specified shear rates by decreasing the shear rate from 10000 s⁻¹ to 6000 s⁻¹, then to 3000 s⁻¹, then to 1500 s⁻¹, then to 1000 s⁻¹, then to 500 s⁻¹, then to 300 s⁻¹ then to 100 s⁻¹, then to 60 s⁻¹, and finally to 30 s⁻¹.

The results are tabulated in Table 2 and demonstrate that the polymeric compositions of the present invention exhibit decreased extensional and decreased shear viscosity compared with the polymer alone in the absence of the acrylic polymer additive. Typically, this may lead to an overall increase in the productivity of a spinning, moulding or film forming process.

TABLE 1
Shear viscosity and extensional viscosity results
measured at 290° C. for polyamide-6,6 and composition 1 of
the present invention (polyamide-6,6 plus 1% by wt of an
acrylic polymer additive 4% EA).

| | Polyamide-6,6 alone | | | Composition 1 | | |
|---|---|---|---|---|---|---|
| | Shear | | Extensional | Shear | | Extensional |
| Shear rate | viscosity | Extensional | Viscosity | viscosity | Extensional | Viscosity |
| per second | Pa · s | stress KPa | KPa · s | Pa · s | stress KPa | KPa · s |
| 30 | 257 | | | | | |
| 50 | 273.2 | | | | | |
| 100 | 256.2 | 36.1 | 1.02 | 198.5 | | |
| 150 | 245.2 | 51.1 | 0.95 | 190.2 | 44.7 | 0.93 |
| 300 | 222.4 | 93.4 | 0.87 | 171.4 | 84.2 | 0.92 |
| 500 | 194 | 162.7 | 1.09 | 134.5 | 120.3 | 0.75 |
| 1000 | 152.3 | 265 | 0.92 | 126.5 | 226.1 | 0.81 |
| 1500 | 132.8 | 379.8 | 0.97 | 110.9 | 304.6 | 0.74 |
| 3000 | 99.7 | 647.2 | 0.93 | 84.56 | 496.6 | 0.65 |
| 5000 | 76.6 | 1036.7 | 1.12 | 66.98 | 723.9 | 0.63 |

TABLE 2
Shear viscosity and extensional viscosity results measured at 230° C. for polypropylene
of MFI 3.5 and compositions 2, 3, 4 and 5 of the present invention (Composition 2 -
polypropylene plus 1% by weight of an acrylic polymer additive 15% nBA; Composition 3 -
polypropylene plus 1% by weight of an acrylic polymer additive 10% nBA; Composition 4 -
polypropylene plus 1% by weight of an acrylic polymer additive 1.75% EA; and Composition 5 -
polypropylene plus 1% by weight of an acrylic polymer additive 3% EA).

| | | | | | | | | | | | | | Composition 5 | | |
|---|---|---|---|---|---|---|---|---|---|---|---|---|---|---|---|
| Shear | Polypropylene Alone | | | Composition 2 | | | Composition 3 | | | Composition 4 | | | | | Ext |
| rate | Shear | Ext | Ext | Shear | Ext | Ext | Shear | Ext | Ext | Shear | Ext | Ext | Shear | Ext | Visc |
| per | Visc | Stress | Visc | Visc | Stress | Visc | Visc | Stress | Visc | Visc | Stress | Visc | Visc | Stress | Kpa · |
| second | Pa · s | KPa | Kpa · s | Pa · s | KPa | Kpa · s | Pa · s | KPa | Kpa · s | Pa · s | KPa | Kpa · s | Pa · s | KPa | s |
| 50 | 615.3 | | | 569.7 | | | 562.5 | | | 551.9 | | | 553.4 | | |
| 100 | 419.7 | | | 402.4 | | | 398.9 | | | 396.3 | | | 389.3 | | |
| 150 | 329.9 | | | 311 | | | 315.6 | | | 313.5 | | | 309 | | |
| 300 | 212.3 | | | 200.2 | | | 205 | | | 203.1 | | | 199.4 | | |
| 500 | 152 | 359.8 | 6.81 | 145.3 | 355 | 6.60 | 147.5 | 342 | 6.34 | 146.6 | 334.2 | 6.1 | 145.7 | 344.8 | 6.55 |
| 1000 | 94.19 | 547.6 | 6.37 | 90.6 | 525.5 | 6.1 | 92.2 | 512.4 | 5.89 | 91.8 | 503.8 | 5.55 | 90 | 501.7 | 5.59 |
| 1500 | 71.43 | 695.2 | 6.02 | 68.1 | 669.4 | 5.85 | 69.2 | 659 | 5.58 | 68.6 | 645.5 | 5.4 | 67.6 | 643.2 | 5.44 |
| 3000 | 42.85 | 1016.5 | 5.56 | 40.61 | 963.1 | 5.08 | 41.6 | 953.4 | 4.85 | 41 | 926.4 | 4.65 | 40.3 | 923.6 | 4.71 |
| 5000 | 28.9 | 1251.9 | 4.34 | 27.77 | 1192.2 | 4.09 | 28.07 | 1174.6 | 3.93 | 27.7 | 1138.8 | 3.75 | 27.2 | 1143.3 | 3.84 |
| 10000 | 16.79 | 1659.9 | 3.28 | 16.12 | 1562.8 | 3.03 | 16.43 | 1571.6 | 3.01 | 15.87 | 1499 | 2.83 | 16.05 | 1507.5 | 2.84 |

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A composition comprising a polymer selected from a polyolefin, a polyamide or mixtures thereof, in admixture with an acrylic polymer additive, wherein:
the shear viscosity of the composition is less than the shear viscosity of the same composition not containing the acrylic polymer additive; or, the extensional viscosity of the composition is less than the extensional viscosity of the same composition not containing the acrylic polymer additive; or,
both the shear viscosity and extensional viscosity of the composition is less than the shear viscosity and extensional viscosity, respectively, of the same composition not containing the acrylic polymer additive,
when measured at an identical applied specific shear rate in the range of 5000 s⁻¹ to 500 s⁻¹ under substantially the same conditions.

2. A composition as claimed in claim 1 wherein the shear viscosity of the composition is less than the shear viscosity of the same composition not containing the acrylic polymer additive.

3. A composition as claimed in claim 1 or 2 wherein the extensional viscosity of the composition is less than the extensional viscosity of the same composition not containing the acrylic polymer additive.

4. A composition as claimed in any one of the preceding claims wherein the shear viscosity of the composition is less than or equal to 98% of the shear viscosity of the same composition not containing the acrylic polymer additive.

5. A composition as claimed in any one of the preceding claims wherein the composition and the same composition not containing the acrylic polymer additive are both molten and at a substantially identical temperature.

6. A composition as claimed in claim 5 wherein the polymer comprises a polyamide and the composition and the same composition not containing the acrylic polymer additive are both at a temperature of between 270° C. to 320° C., preferably 290° C.

7. A composition as claimed in claim 5 wherein the polymer comprises a polyolefin and the composition and the same composition not containing the acrylic polymer additive are both at a temperature of between 170° C. to 230° C., preferably 230° C. when the polyolefin comprises polypropylene.

8. A composition as claimed in any one of the preceding claims wherein the shear viscosity of the composition is less than the shear viscosity of the polymer alone when measured at an identical applied specific shear rate in the range of 5000 s⁻¹ to 500 s⁻¹ under substantially the same conditions.

9. A composition as claimed in any one of the preceding claims wherein the extensional viscosity of the composition is less than the extensional viscosity of the polymer alone when measured at an identical applied specific shear rate in the range of 5000 s⁻¹ to 500 s⁻¹ under substantially the same conditions.

10. A composition as claimed in claim 8 or 9 wherein the composition and the polymer alone are both molten and at a substantially identical temperature.

11. A composition as claimed in claim 10 wherein the polymer comprises a polyamide and the composition and the polymer alone are both at a temperature of between 270° C. to 320° C., preferably 290° C.

12. A composition as claimed in claim 10 wherein the polymer comprises a polyolefin and the composition and the polymer alone are both at a temperature of between 170° C. to 230° C., preferably 230° C. when the polyolefin comprises polypropylene.

13. A composition as claimed in any one of the preceding claims wherein the identical applied specific shear rate is 3000 s⁻¹.

14. A composition as claimed in claim 13 wherein the extensional viscosity of the composition is less than or equal to 95% the extensional viscosity of the same composition not containing the acrylic polymer additive.

15. A composition as claimed in claim 13 wherein the extensional viscosity of the composition is less than or equal to 95% the extensional viscosity of the polymer alone.

16. A composition as claimed in any one of the preceding claims wherein the extensional stress of the composition is greater than or equal to 100 KPa.

17. A composition as claimed in any one of the preceding claims wherein the acrylic polymer additive comprises a homopolymer or copolymer derived from a monomer mixture comprising 80 to 100 wt % of methyl methacrylate, 0 to 20 wt % of at least one other copolymerisable alkyl (alk)acrylate comonomer, 0 to 0.5 wt % of an initiator, and 0 to 0.1 wt % of a chain transfer agent.

18. A composition as claimed in claim 15 wherein the acrylic polymer additive is an acrylic copolymer derived from a mixture comprising 80 to 99.9% by weight of methyl methacrylate and 0.1 to 20% by weight of at least one other copolymerisable alkyl (alk)acrylate.

19. A composition as claimed in claim 18 wherein the alkyl (alk)acrylate comprises an alkyl acrylate, preferably a (C₁-C₄) alkyl acrylate.

20. A composition as claimed in any one of the preceding claims wherein the acrylic polymer additive has a weight average molecular weight of greater than or equal to 50,000.

21. A composition as claimed in any one of the preceding claims wherein the acrylic polymer additive is present in an amount of at least 0.5 wt % based on the total weight of the composition.

22. A composition as claimed in any one of the preceding claims wherein the acrylic polymer additive is present in an amount of less than or equal to 15 wt % based on the total weight of the composition.

23. A composition as claimed in any one of the preceding claims wherein the acrylic polymer additive is immiscible with the polymer.

24. A composition as claimed in any one of the preceding claims wherein the composition is molten.

25. A composition as claimed in any one of the preceding claims wherein the polyamide comprises a nylon, preferably nylon-6,6 or nylon-6.

26. A composition as claimed in any one of the preceding claims wherein the polyolefin comprises a homopolymer or copolymer derived from a monomer mixture comprising a mono-alkene monomer and at least one other copolymerisable mono-alkene comonomer.

27. A composition as claimed in claim 26 wherein the polyolefin comprises polyethylene or polypropylene.

28. A composition as claimed in any one of the preceding claims wherein the polymer is a homopolymer.

29. A process for preparing a composition as defined in any one of claims 1 to 28 comprising adding an acrylic polymer additive as defined in any one of claims 1 to 28 to a polymer selected from a polyamide, a polyolefin or mixtures thereof.

30. A process as claimed in claim 29 wherein the acrylic polymer additive is melt-blended with the polymer.

31. A process as claimed in claim 29 or 30 wherein non-molten acrylic polymer additive is added to a melt of the polymer.

32. A fibre comprising the composition as defined in any one of claims 1 to 28.

33. A shaped article comprising the composition as defined in any one of claims 1 to 28.

34. A film comprising the composition as defined in any one of claims 1 to 28.

35. Use of an acrylic polymer additive as defined in any one of claims 1 to 28 for decreasing the extensional viscosity and/or shear viscosity of a polymer, particularly a polyamide or polyolefin as defined in any one of claims 1 to 28.
